(19) United States
(12) Patent Application Publication
(10) Pub. No.: US 2015/0190297 A1
(43) Pub. Date: Jul. 9, 2015

(54) ARM SUPPORT APPARATUS FOR PRONE PATIENTS

(71) Applicant: Arun Rajagopal, Salt Lake City, UT (US)

(72) Inventor: Arun Rajagopal, Salt Lake City, UT (US)

(21) Appl. No.: 14/559,322

(22) Filed: Dec. 3, 2014

Related U.S. Application Data
(60) Provisional application No. 61/924,414, filed on Jan. 7, 2014.

(51) Int. Cl. A61G 13/12

(52) U.S. Cl. CPC A61G 13/1235

(57) ABSTRACT

Novel devices and apparatus are provided to support the arms of a person when lying in the prone position. In preferred embodiments, an arm supporting apparatus comprises an elongate center panel with a generally planar top surface, a first arm board connected to the center panel at one end, and a second arm board connected to the center panel at a second end. In some further embodiments, the first and second arm boards are adapted to swing or pivot from an extended position whereby the arm boards are generally level with the center panel to a lowered depressed position. In yet further embodiments, the arm boards may curve or slope upwards at their distal ends helping to secure a person's arms and prevent them from falling off of the boards.

### CROSS REFERENCE TO RELATED APPLICATIONS

This application claims priority to and the benefit of the filing date of U.S. Provisional Application No. 61/924,414, filed on Jan. 7, 2014, entitled “SURGICAL BED ARM SUPPORT FOR PRONE PATIENTS”, which is hereby incorporated by reference in its entirety.

### FIELD OF THE INVENTION

This patent specification relates to the field of devices for supporting or stabilizing a portion of the human anatomy during procedures and therapies. More specifically, this patent specification relates to rotating arm boards for supporting a patient's arms in the prone position.

### BACKGROUND

During medical procedures and therapies, a patient may be asked to lie in a prone position for extended periods of time on an examination or therapy table. Currently, there are several medical examination tables with arm boards configured to support an arm or another body part of a patient. These medical examination tables are constructed with built in arm boards, but these solutions fail to meet the cost effective needs of the market because the cost of these medical tables are typically very expensive and their unitary construction makes them difficult to repair them should a component fail.

Other attempts at providing arm supporting structures include separate arm boards that attach to medical examination tables post retail, but, these structures are similarly unable to meet the needs of the market because they must be clamped on to the table which limits the position of use. In addition, the clamping mechanism is often proprietary which further limits the breadth of use on various tables.

Still other attempts at providing arm supporting structures consist of arm boards that do not clamp or bolt on to the table. These structures are often wedged under portions of the patient with the patient's own body weight holding them in place. In some instances the patient may inadvertently move their body which may result in the supporting structure becoming unbalanced and falling. These arm supporting structures fail to meet market needs because they lack stability.

Therefore, a need exists for novel supporting structures and apparatuses that serve as an efficient, cost-effective board for supporting a patient's arms during medical procedures and the like. There is a further need for novel supporting structures and apparatuses that are not limited in the position of use by being clamped onto medical examination tables. Another need exists for novel supporting structures and apparatuses that do not require a proprietary clamping mechanism which limits the breadth of use on various tables from different manufactures.

### BRIEF SUMMARY OF THE INVENTION

Novel devices and apparatus are provided to support the arms of a person when lying in the prone position. In preferred embodiments, an arm supporting apparatus comprises an elongate center panel with a generally planar top surface, a first arm board connected to the center panel at one end, and a second arm board connected to the center panel at a second end. In some further embodiments, the first and second arm boards are adapted to swing or pivot from an extended position whereby the arm boards are generally level with the center panel or in a lowered or raised depressed position. In yet further embodiments, the arm boards may curve or slope upwards at their distal ends helping to secure a person's arms without the need for restraints and prevent them from falling off of the boards.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of an arm support apparatus for prone patients shown in the extended position according to various embodiments described herein.

FIG. 2 illustrates a perspective view of an example of an arm support apparatus for prone patients in a downward folded or lowered depressed position according to various embodiments described herein.

FIG. 3 shows a perspective view of an example of an arm support apparatus for prone patients shown in a partially folded position according to various embodiments described herein.

FIG. 4 depicts a perspective view of an example of an arm support apparatus for prone patients shown in an upward folded position according to various embodiments described herein.

FIG. 5 illustrates a plan view of the bottom of an example of an arm support apparatus for prone patients in an extended and locked position according to various embodiments described herein.

FIG. 6 shows a perspective view of an example of an arm support apparatus for prone patients in an extended and locked position supporting the arms of a patient according to various embodiments described herein.

FIG. 7 depicts a perspective partial view of an example of an alternative embodiment of an arm support apparatus for prone patients.

FIG. 8 illustrates a sectional, through line 8-8 shown in FIG. 2, elevation view of an example of an arm board with cushion pad according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New patient support devices and apparatuses are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

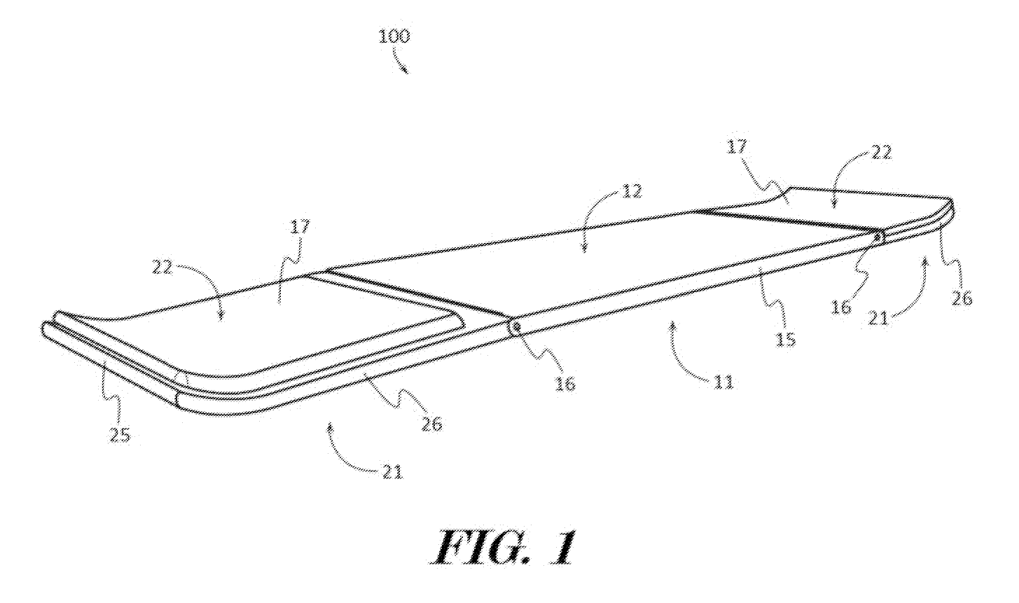

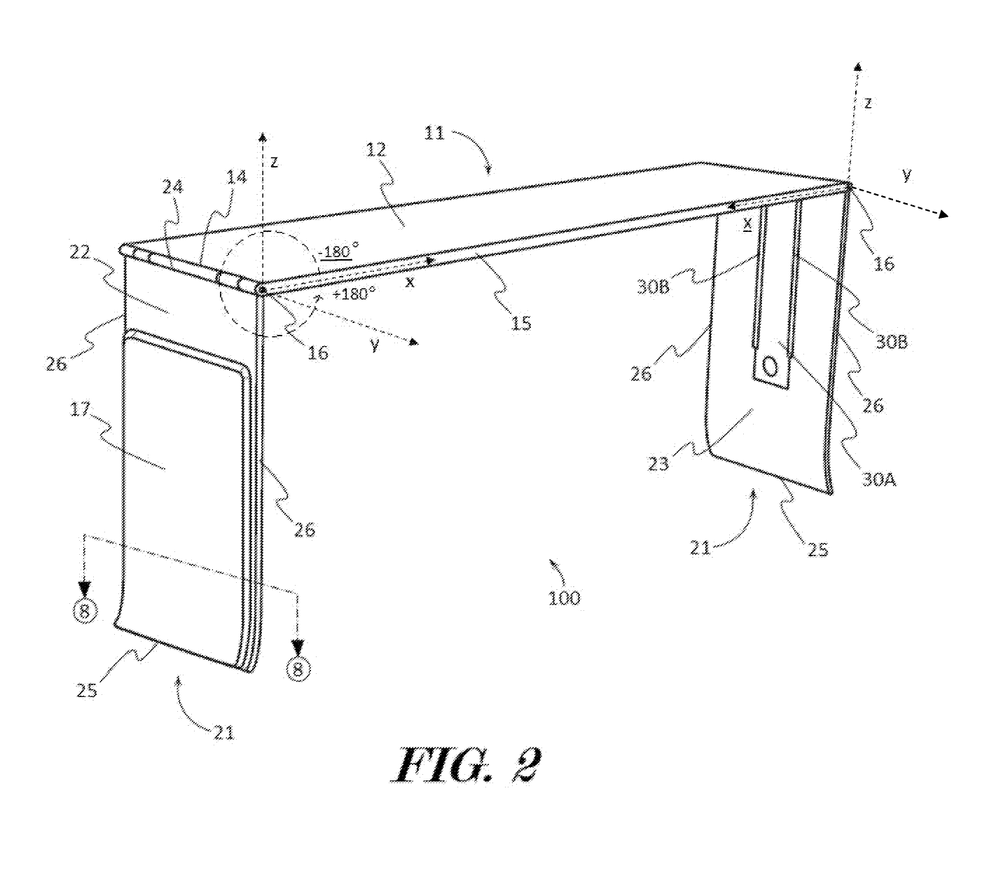

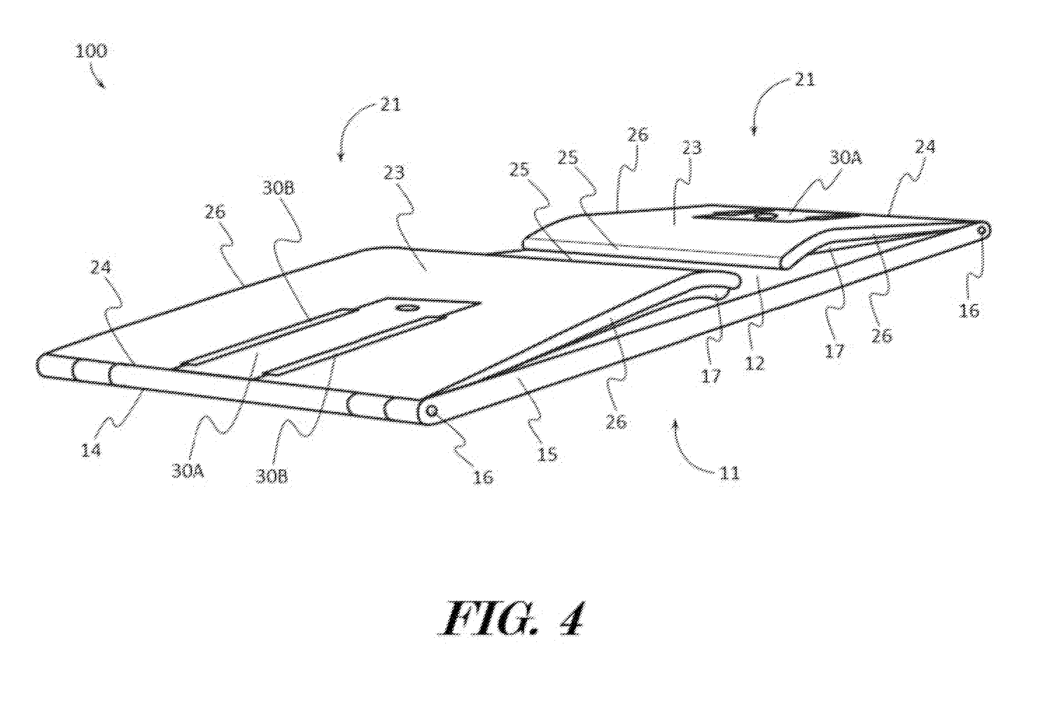

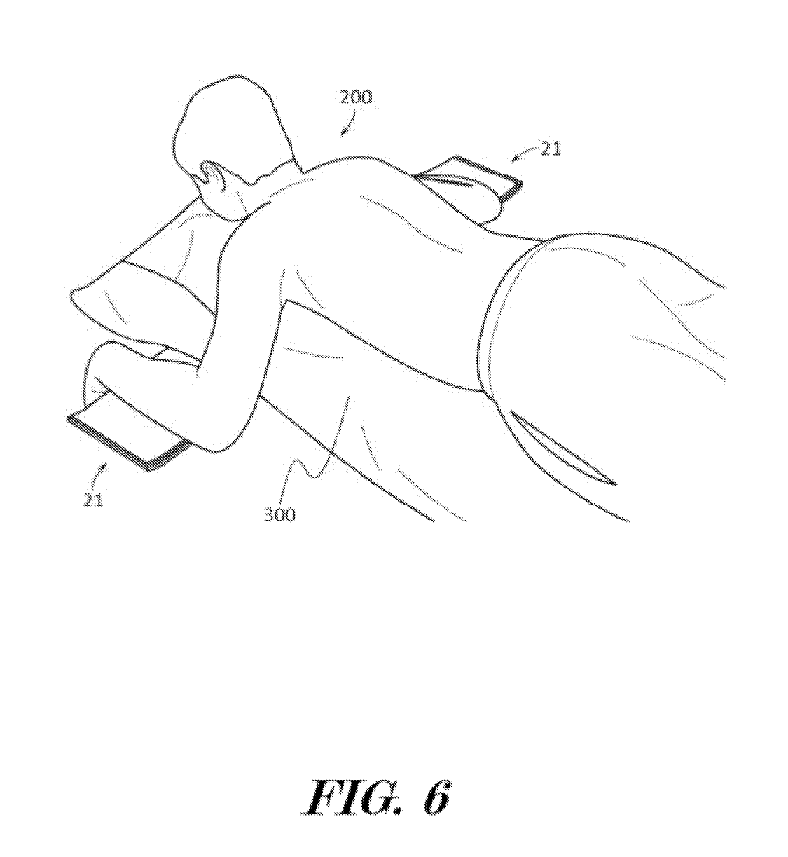

The present invention will now be described by example and through referencing the appended figures representing preferred and alternative embodiments. FIG. 1 illustrates an example of an arm support apparatus for prone patients (“the apparatus”) 100 according to various embodiments. In this example, the apparatus 100 comprises a center panel 11 rotatably coupled to two arm boards 21. The arm boards 21 may each be configured to rotate or swing about a hinged coupling 16 and to temporarily lock in an extended position (FIGS. 1, 5, and 6) with the arm boards 21 in the same general plane as or co-planar with the center panel 11. The apparatus 100 may be positioned beneath a patient and/or under a bed or cushion that may be supporting the patient with the center panel 11 positioned below the patient's back, shoulders or chest, and the arm boards 21 may be positioned in the extended position and one or both of the patient's arms may be placed on and supported by an arm board 21 (FIG. 6). When not in use, the arm boards 21 may be rotated about the hinged coupling and out of the extended position and into another position such as a raised position (FIG. 4) or a lower depressed position (FIG. 2). In one example of the principled disclosed herein, the apparatus may be removably affixed to the examination table through standard devices, such as bolts or clamps. In other examples, the apparatus may be held in position by the weight of the patient alone.

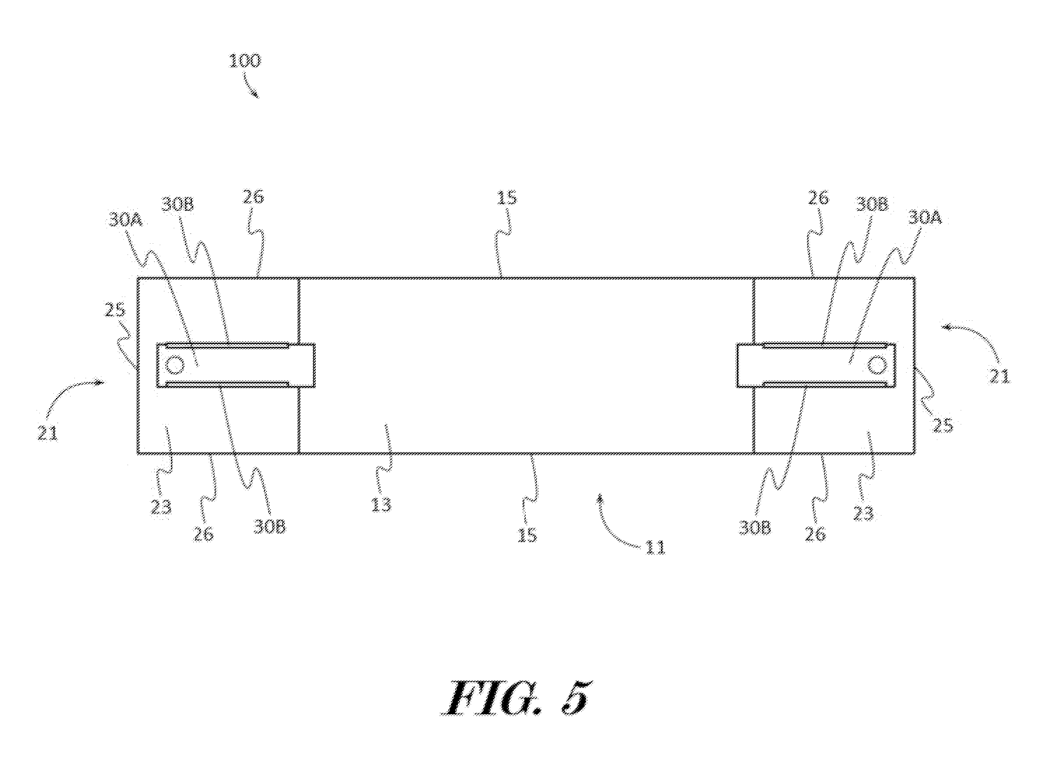

Referencing now to FIG. 1 and FIG. 5, a center panel 11, a first arm board 21, and a second arm board 21 may each comprise a generally planar rectangular shape with a height dimension that is substantially less than the length dimension and the width dimension. It should be understood to one of ordinary skill in the art that in other embodiments, a center panel 11, a first arm board 21, and/or a second arm board 21 may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. In further embodiments, a center panel 11, a first arm board 21, and/or a second arm board 21 may be configured in curved or uncurved shapes such as a Saddle surface with normal planes in directions of principal curvatures, Gaussian curvature, hyperboloids, and the like. It is not intended herein to mention all the possible alternatives, equivalent forms or ramifications of the invention. It is understood that the terms and proposed shapes used herein are merely descriptive, rather than limiting, and that various changes may be made without departing from the spirit or scope of the invention.

In preferred embodiments and as best shown in FIG. 1 and FIG. 5, a center panel 11 may comprise a generally planar center panel top surface 12 and an opposing generally planar center panel bottom surface 13. Preferably, the center panel top surface 12 may be positioned below the patient's back, shoulders or chest, while the center panel bottom surface 13 may contact an examination table or the like. In some embodiments, the center panel top surface 12 and the center panel bottom surface 13 may be textured with a pattern such as grooves, waves, circles, lines, or any suitable pattern to increase the friction between those surfaces and the table or pad and help prevent slippage and movement. In yet further embodiments, the center panel top surface 12 and the center panel bottom surface 13 may be coupled to or coated with a non-slip material such as rubber or foam matting. A first center panel end edge 14 (FIGS. 2, 4, 7) and a second center panel end edge 14 (FIGS. 2, 4, 7) may be located generally parallel and opposite to each other, along the width dimensions of the center panel top surface 12 and the center panel bottom surface 13. A first center panel longitudinal side edge 15 and a second center panel longitudinal side edge 15 may be located generally parallel and opposite to each other and generally perpendicular to the first center panel end edge 14 and the second center panel end edge 14, along the length dimensions of the center panel top surface 12 and the center panel bottom surface 13. In some embodiments, all or portions of the first center panel end edge 14, the second center panel end edge 14, the first center panel longitudinal side edge 15, and/or the second center panel longitudinal side edge 15 may be rounded, beveled, angled, curved, or the like to facilitate the positioning of the center panel 11 under a patient or under the pad of an examination table.

Also in preferred embodiments and as best shown in FIG. 1 and FIG. 5, an arm board 21 may comprise a generally planar arm board top surface 22 and an opposing generally planar arm board bottom surface 23. Preferably, the arm board top surface 22 may be positioned below the patient's arms, while the arm board bottom surface 23 may be orientated towards the floor, an examination table, or the like. An arm board proximate end 24 (FIGS. 2-4) and an arm board distal end 25 may be located generally parallel and opposite to each other, along the width dimensions of the arm board top surface 22 and the arm board bottom surface 23. A first arm board longitudinal side edge 26 and a second arm board longitudinal side edge 26 may be located generally parallel and opposite to each other and generally perpendicular to the arm board proximate end 24 and the arm board distal end 25, along the length dimensions of the board top surface 12 and the board bottom surface 13. In some embodiments, the arm board 21 may comprise a first arm board longitudinal side edge 26 and a second arm board longitudinal side edge 26 positioned opposite to each other with the arm board longitudinal side edges 26 being substantially linear proximate to the center panel 11 and non-linear proximate to the arm board distal end 25. In some embodiments, all or portions of the arm board proximate end 24, the arm board distal end 25, the first arm board longitudinal side edge 26, and/or the second arm board longitudinal side edge 26 may be rounded, bent, beveled, angled, curved, or the like to facilitate the positioning of the arm board 21 under a patient or under the pad of an examination table.

As shown in FIGS. 1, 5, and 6, the apparatus 100 may assume an extended position when the first arm board top surface 22 and the second arm board top surface 22 is substantially co-planar or level with the center panel top surface 12. In some embodiments, the arm board 21 may be substantially co-planar, level, or considered generally in the same plane as a center panel 11 when portions of the arm board 21 such as the arm board top surface 22 are within plus or minus ten degrees to portions of the center panel 11 such as the center panel top surface 12 about the y-axis of rotation (see FIG. 2) provided by the hinged coupling 16.

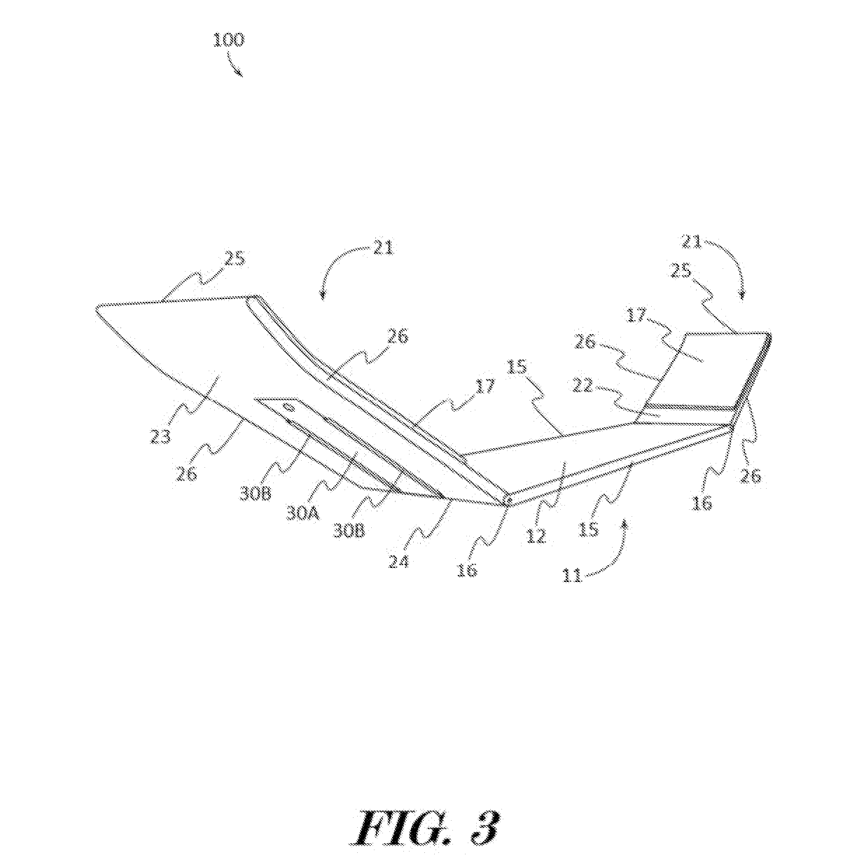

FIG. 2 illustrates a perspective view of an example of an arm support apparatus for prone patients 100 in a lower depressed position according to various embodiments described herein. In this embodiment, both arm boards 21 of the apparatus 100 have been rotated so the arm board distal end 25 of each arm board 21 is generally positioned the farthest distance from the center panel top surface 12, having been rotated about the y-axis provided by the axis of the hinged coupling 16. While the apparatus 100 is preferably removably positioned under portions of a patient's upper torso on an examination table, the arm boards 21 may be rotated at the hinged coupling 16 allowing the apparatus to assume a lower depressed position. The arm boards 21 may be maintained in a lower depressed position through the action of gravity, or the hinged coupling 16 may be configured to arrest the rotation ability by a mechanical or electrical locking method. Further, the arm boards 21 may be rotated completely underneath the center panel 11, on top of the center panel 11 (as illustrated in FIG. 4) or at intermediate positions (as illustrated, for example, in FIGS. 2 and 3). The mechanical or electrical locking mechanism or method may be configured or programmed to arrest the arm boards 21 at any desired location with respect to the y-axis of rotation—e.g., anywhere from 180 degrees (rotated completely on top of the center panel) to −180 degrees (rotated completely underneath the center panel 11). During procedures, the arm boards 21 will typically be rotated to about 0 degrees—i.e., extending substantially parallel or co-planar with the top or bottom surface of the center panel 11—though a slight downward rotation—e.g., about 10 or 20 degrees—may provide increased comfort for the patient.

As shown in FIG. 2, an apparatus 100 may assume a lower depressed position when the first arm board top surface 22 and the second arm board top surface 22 is substantially perpendicular to the center panel top surface 12. In some embodiments, an arm board 21 may be substantially perpendicular to a center panel 11 when portions of an arm board 21 such as the arm board top surface 22 are rotated to within about 80 to 100 degrees from being parallel to the center panel 11—i.e., pointing substantially downward toward a floor surface.

FIG. 3 shows a perspective view of an example of an arm support apparatus for prone patients 100 transitioning along the y-axis between a raised position and an extended position according to various embodiments described herein. In this embodiment, both arm boards 21 of the apparatus 100 have been rotated along the y-axis provided by the hinged couplings 16 so the each arm board 21 is generally not positioned in the same plane or not co-planar as the center panel 11. One skilled in the art will immediately recognize that the arm boards 21 may be rotated independently from each other around the y-axis provided by the hinged couplings 16 allowing the arm boards 21 to be oriented in a plurality of positions from each other and from the center panel 11.

FIG. 4 depicts a perspective view of an example of an arm support apparatus for prone patients 100 in a raised position according to various embodiments described herein. In some embodiments and in the present example, one or both arm boards 21 may be rotated about the y-axis at the hinged coupling 16 so that an arm board top surface 22 of an arm board 21 may be brought in close proximity or in contact with a center panel top surface 12 of a center panel 11 allowing the apparatus 100 to assume a raised position. The raised position may facilitate the storage of the apparatus 100 by allowing the apparatus 100 to occupy a smaller storage footprint than the extended position (FIGS. 1, 5, and 6).

In preferred embodiments, the hinged coupling 16 may comprise a piano hinge which may be formed with one or more portions of an arm board proximate end 24 of which are configured to interlock with one or more portions of a center panel end edge 14, thereby forming a rotatable coupling or bearing which connects an arm board 21 to a center panel 11 and that is configured to allow an angle of rotation around the y-axis between the arm board 21 to a center panel 11. In other embodiments, the hinged coupling 16 may comprise a butt hinge, barrel hinge, butt/Mortise hinge, case hinge, flag hinge, strap hinge, H hinge, HL hinge, piano hinge, butterfly hinge, flush hinge, barrel hinge, concealed hinge, continuous hinge, T-hinge, strap hinge, double-acting hinge, Soss hinge, counterflap hinge, flush hinge, coach hinge, rising butt hinge, double action spring hinge, tee hinge, friction hinge, security hinge, cranked hinge or storm proof hinge, lift-off hinge, self closing or self positioning hinge, flexible material hinge, or any other type or style of hinge suitable for pivotally joining an arm board 21 to a center panel 11.

FIG. 5 illustrates a plan view of the bottom of an example of an arm support apparatus for prone patients 100 in an extended position with the center panel bottom surface 13 and the board bottom surfaces 23 of the two arm boards 21 visible according to various embodiments described herein. In various embodiments and as shown in FIGS. 2-5, the apparatus 100 may comprise one or more locking mechanisms such as a lock tab 30A and a lock tab guide rail mechanism 30B which may be configured to temporarily arrest the pivoting ability of the arm board 21 relative to the center panel 11, thereby securing the arm board 21 into an extended position. A locking mechanism such as the lock tab 30A may be configured to slidably engage between two lock tab guide rails 30B. The lock tab 30A may be slidably coupled to the arm board 21 and may be configured to slide within a channel optionally formed by the two lock tab guide rails 30B. The lock tab guide rails 30B may be permanently coupled to or integrally formed within an arm board bottom surface 23 with a lock tab 30A configured to slide within a channel formed by two lock tab guide rails 30B. By sliding the lock tab 30A into and across the axis of rotation provided by the hinged coupling 16 and into contact with portions of a center panel bottom surface 13 as shown in FIG. 5, the rotational ability of the hinged coupling 16 and the arm board 21 may be mechanically arrested. By sliding the lock tab 30A out of the axis of rotation provided by the hinged coupling 16 and withdrawing the lock tab 30A from contact with portions of a center panel bottom surface 13, the rotational ability of the hinged coupling 16 and the arm board 21 may be restored.

In some embodiments, the lock tab 30A may be slidably coupled to the arm board bottom surface 23 and the lock tab guide rails 30B may be permanently coupled to or integrally formed within a bottom surface of a center panel bottom surface 13. In other embodiments, a lock tab 30A may be slidably coupled to the center panel bottom surface 13 and the lock tab guide rails 30B may be permanently coupled to or integrally formed within an arm board bottom surface 23.

In some embodiments, when slid into and across the axis of rotation provided by the hinged coupling 16 and into contact with portions of the center panel bottom surface 13, the lock tab 30A may be configured to support the arm board 21 in an extended position with the arm board 21 in generally the same plane as the center panel 11 (i.e., co-planar) as shown in FIGS. 1, 5, and 6. In other embodiments, when slid into and across the axis of rotation provided by the hinged coupling 16 and into contact with portions of the center panel bottom surface 13, the lock tab 30A may be configured to support the arm board 21 in an extended position with the arm board 21 in generally above or below the plane of the center panel 11.

As perhaps best shown in FIGS. 1-4 and in the embodiments described herein, the arm board distal end 25 of the arm board 21 may be curved towards the arm board top surface 22 of the arm board 21. In other embodiments, the arm board distal end 25 of the arm board 21 may be curved towards the board bottom surface 22 of the arm board 21. In alternative embodiments, the arm board distal end 25 of the arm board 21 may be angled towards the arm board top surface 22 of the arm board 21. In other alternative embodiments, the arm board distal end 25 of the arm board 21 may be angled towards the board bottom surface 22 of the arm board 21.

In one example, a substantial portion of the arm board top surface 22 may be generally planar so that when the apparatus 100 is in the extended position (FIGS. 1, 5, and 6), a substantial portion of the arm board top surface 22 of the arm boards 21 and the center panel top surface 12 of the center panel 11 are in generally the same plane, while portions of the arm board top surface 22 including the arm board distal end 25 may be raised slightly above the substantial portion of the first and second arm board top surface 22 that are planar. In some embodiments, a substantial portion of the arm board top surface 22 may comprise between 51% to 100% of the arm board top surface 22 as generally planar so that when the apparatus 100 is in the extended position, the majority of the arm board top surface 22 of the arm boards 21 and the center panel top surface 12 of the center panel 11 may be in generally the same plane. In other embodiments, 1.0% to 51% of the arm board top surface 22 may be generally planar so that when the apparatus 100 is in the extended position, 1.0% to 51% of the arm board top surface 22 of the arm boards 21 and the center panel top surface 12 of the center panel 11 may be in generally the same plane.

FIG. 6 shows a perspective view of an example of an arm support apparatus for prone patients 100 in an extended position supporting the arms of a patient 200 according to various embodiments described herein. As perhaps best illustrated by FIG. 6, portions of a center panel 11 may be positioned under the upper torso of a patient 200 and preferably removably positioned on top of a table such as an examination table 300 and under a covering such as an examination table pad as shown by FIG. 6, disposable sanitary covering, or the like. When positioned in an extended position, with the first arm board top surface 22 (FIGS. 1,2,3,8) and second arm board top surface 22 substantially co-planar with the center panel top surface 11, the patient's chest or back may rest on or above the center panel top surface 11 while the patient's first and/or second arm may be supported by the first arm board top surface 22 and/or second arm board top surface 22, respectively. In some embodiments, the weight of the patient's torso and/or weight of the person's arms may facilitate the stable engagement of the apparatus 100 to a patient support structure such as a medical examination table.

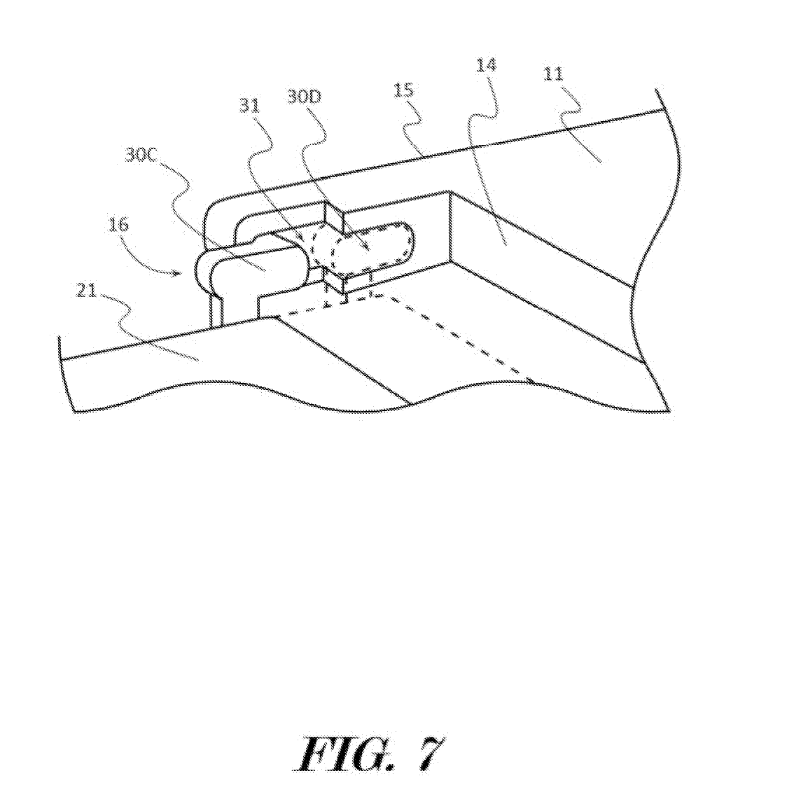

FIG. 7 depicts a perspective partial view of an example of an arm support apparatus for prone patients 100 comprising a hinged coupling 16 which is rotatably coupling an arm board 21 to a center panel 11 according to various embodiments described herein. In this alternative embodiment, the hinged coupling 16 may be configured to rotatably couple the arm board 21 to the center panel 11 and also to temporarily arrest the rotational ability of the arm board 21 relative to the center panel 11. The hinged coupling 16 may comprise a locking mechanism such as an offset tab 30C which may be temporarily inserted into a tab slot 30D. The portions of the hinged coupling 16 may be configured to be rotatably coupled and slidably coupled within a coupling channel 31 which may be joined to a center panel longitudinal side edge 15 and/or a center panel end edge 14. By sliding the arm board 21 towards the center panel 11, portions of the hinged coupling may slide within the coupling channel 31 and the offset tab 30C may be inserted into the tab slot 30D which may inhibit the rotational ability of the hinged coupling 16. By sliding the arm board 21 away from the center panel 11, portions of the hinged coupling may slide within the coupling channel 31 and the offset tab 30C may be freed from the tab slot 30D, thereby restoring the rotational ability of the hinged coupling 16.

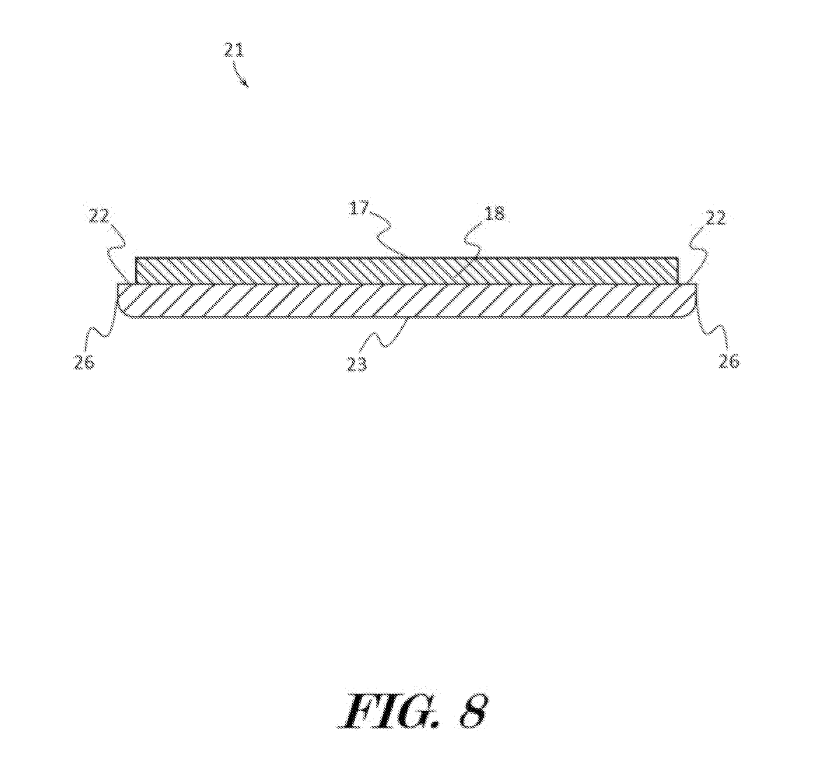

FIG. 8 illustrates a sectional, through line 8-8 shown in FIG. 2, elevation view of an example of an arm board 21 according to various embodiments described herein. In some preferred embodiments, an arm board top surface 22 of a first arm board 21, an arm board top surface 22 of a second arm board 21, and/or a center panel top surface 12 (FIGS. 1-5, and 7) may comprise a cushion pad 17 or other suitable cushion layer. A cushion pad 17 may cover all or portions of an arm board top surface 22 or a center panel top surface 12 and may be configured to absorb impacts or provide a resilient cushioning layer between a patient and an arm board 21 or center panel 11. In some embodiments, a cushion pad 17 may comprise a cushion layer 18 such as neoprene foam. In other embodiments, a cushion pad 17 may comprise a cushion layer 18 such as silicone rubber, silicone foams, rubber foams, plastic foams, latex foam rubber, polyurethane foam rubber, or elastomer materials such as elastic plastics, elastic silicone, elastic rubbers, silicone rubbers, or any other suitable elastomer or resilient material.

In some embodiments, an arm board top surface 22 of a first arm board 21, an arm board top surface 22 of a second arm board 21, and/or a center panel top surface 12 of a center panel 11 (FIGS. 1-5, and 7) may comprise a removably coupled cushion pad 17 or other suitable cushion layer. A cushion pad 17 may be removably coupled to an arm board top surface 22 or a center panel top surface 12 by being press fit or snap fit together, by one or more hook and loop type fasteners such as Velcro type fasteners, sealable tongue and groove fasteners, clip type fasteners, clasp type fasteners, ratchet type fasteners, threaded type fasteners such as screws and bolts, buckle type fasteners and the like, or any other suitable joining method capable of temporarily coupling or securing portions of a cushion pad 17 to an arm board top surface 22 or a center panel top surface 12.

In other embodiments, an arm board top surface 22 of a first arm board 21, an arm board top surface 22 of a second arm board 21, and/or a center panel top surface 12 of a center panel 11 (FIGS. 1-5, and 7) may comprise a substantially permanently coupled cushion pad 17 or other suitable cushion layer. A cushion pad 17 may be substantially permanently coupled to an arm board top surface 22 or a center panel top surface 12 with heat bonding, chemical bonding, adhesives, clasp type fasteners, clip type fasteners, rivet type fasteners, threaded type fasteners, other types of fasteners, by being integrally molded or formed together, or any other suitable joining method capable of substantially permanently securing portions of a cushion pad 17 to an arm board top surface 22 or a center panel top surface 12.

The elements that comprise the apparatus 100 such as a center panel 11 (FIGS. 1-5, and 7), arm boards 21 (FIGS. 1-8), hinged coupling 16 (FIGS. 1-5, and 7), and locking mechanisms such as a lock tab 30A (FIGS. 1-5), lock tab guide rail 30B (FIGS. 2-5), offset tab 30C (FIG. 8), tab slot 30D (FIG. 8), and/or coupling channel 31 (FIG. 8) may be made from durable materials such as hard plastics, radiologically translucent plastics, metal alloys, wood, hard rubbers, carbon fiber, or any other suitable materials including combinations of materials. Additionally, one or more elements may be made from durable and slightly flexible materials such as soft plastics, silicone, soft rubbers, or any other suitable materials including combinations of materials. As used herein the term “substantially” shall mean a majority of a something, such as at least 60% of something, but preferably at least 70% of something, and more preferably at least 80% of something. In this regard, a surface that is substantially planar shall, in some embodiments, mean the surface is at least 60% planar, or preferably at least 70% planar, or optionally at least 80% planar.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An apparatus for supporting the arms of patients, the apparatus comprising:
a center panel configured to be removably positioned upon an examination table and below the body of the patient, the center panel having a top surface, a bottom surface, a first panel end edge, and a second panel end edge positioned opposite the first panel end edge;
a first arm board having a top surface, a bottom surface, a distal end, and a proximate end positioned opposite the distal end, the proximate end rotatably coupled to the first panel end edge and configured to rotate about a first hinge in a vertical direction; and;
a second arm board having a top surface, a bottom surface, a distal end, and a proximate end positioned opposite the distal end, the proximate end rotatably coupled to the second panel end edge and configured to rotate about a second hinge in a vertical direction.

2. The apparatus of claim 1, wherein the first hinge is configured to permit rotation of the first arm board between a first position and a second position and the second hinge is configured to permit rotation of the second arm board between a first position and a second position.

3. The apparatus of claim 2, wherein the top surface of the first arm board and the top surface of the center panel face each other when the first arm board is in the first position and wherein the top surface of the second arm board and the top surface of the center panel face each other when the second arm board is in the first position.

4. The apparatus of claim 3, wherein the top surface of the first arm board and the top surface of the center panel are substantially co-planar when the first arm board is in the second position and wherein the top surface of the second arm board and the top surface of the center panel are substantially co-planar when the second arm board is in the second position.

5. The apparatus of claim 4, further comprising a first lock mechanism configured to releasably lock the first panel in the second position and a second lock mechanism configured to releasably lock the second panel in the second position.

6. The apparatus of claim 2, wherein the bottom surface of the first arm board and the bottom surface of the center panel face each other when the first arm board is in the first position and wherein the bottom surface of the second arm board and the bottom surface of the center panel face each other when the second arm board is in the first position.

7. The apparatus of claim 6, wherein the top surface of the first arm board and the top surface of the center panel are substantially co-planar when the first arm board is in the second position and wherein the top surface of the second arm board and the top surface of the center panel are substantially co-planar when the second arm board is in the second position.

8. The apparatus of claim 7, further comprising a first lock mechanism configured to releasably lock the first panel in the second position and a second lock mechanism configured to releasably lock the second panel in the second position.

9. An apparatus for supporting the arms of patients, comprising:
a center panel configured for removable positioning upon an examination table, the center panel having a top surface, a bottom surface, a first panel end edge, and a second panel end edge positioned opposite the first panel end edge;
a first arm board rotatably coupled to the first panel edge of the center panel, the first arm board having a top surface, a bottom surface, a distal end, and a proximate end positioned opposite the distal end; and
a second arm board rotatably coupled to the second panel edge of the center panel, the second arm board having a top surface, a bottom surface, a distal end, and a proximate end positioned opposite the distal end.

10. The apparatus of claim 9, wherein the first arm board is configured to rotate between a first position and a second position and the second arm board is configured to rotate between a first position and a second position.

11. The apparatus of claim 10, wherein the top surface of the first arm board and the top surface of the center panel face each other when the first arm board is in the first position and wherein the top surface of the second arm board and the top surface of the center panel face each other when the second arm board is in the first position.

12. The apparatus of claim 11, wherein the top surface of the first arm board and the top surface of the center panel are substantially co-planar when the first arm board is in the second position and wherein the top surface of the second arm board and the top surface of the center panel are substantially co-planar when the second arm board is in the second position.

13. The apparatus of claim 12, further comprising a first lock mechanism configured to releasably lock the first panel in the second position and a second lock mechanism configured to releasably lock the second panel in the second position.

14. The apparatus of claim 13 wherein the first arm board is configured to rotate to a third position extending substantially perpendicular to the center panel at an angle of about −90 degrees when the first lock mechanism is released and wherein the second arm board is configured to rotate to a third position extending substantially perpendicular to the center panel at an angle of about −90 degrees when the second lock mechanism is released.

15. The apparatus of claim 9 wherein the distal ends of the first and second arm boards are raised above the proximate ends of the first and second arm boards.

16. The apparatus of claim 15 wherein the first and second arm boards further comprise parallel longitudinal side edges positioned opposite each other with the longitudinal side edges being substantially straight proximate the center panel and curved proximate the distal ends of the arm boards.

17. The apparatus of claim 16 wherein the longitudinal side edges are curved in the positive z-direction proximate the distal ends of the arm boards.

18. The apparatus of claim 9 wherein the arm boards comprise a cushion pad.

19. A removable arm support apparatus to support the arms of a person, said apparatus configured for positioning on top of an examination table, said apparatus having a center panel coupled to an arm board, the arm board configured to rotate about an axis in vertical motion relative to the center panel between:
an extended position where the arm board is substantially co-planar with the center panel;
an upward folded position where the arm board is positioned above the center panel; and
a lower depressed position where the arm board is positioned below the center panel.

20. The apparatus of claim 19 wherein the center panel has a bottom surface with a texture configured to reduce the movement between the apparatus and the examination table.
